(19) United States
(12) Patent Application Publication
(10) Pub. No.: US 2010/0071999 A1
(43) Pub. Date: Mar. 25, 2010

(54) SPRING MOTOR

(76) Inventor: Michel LECLERC, Laval (CA)

Correspondence Address: GOUDREAU GAGE DUBUC, 2000 MCGILL COLLEGE, SUITE 2200, MONTREAL, QC, H3A 3H3, CA

(21) Appl. No.: 12/563,581

(22) Filed: Sep. 21, 2009

Related U.S. Application Data
(60) Provisional application No. 61/098,368, filed on Sep. 19, 2008.

(51) Int. Cl. F03G 1/00; F03G 1/06; F03G 1/02; F03G 1/08

(52) U.S. Cl. 185/38; 185/37; 185/39; 185/40 R

(57) ABSTRACT

A spring motor for driving a driving shaft, comprising a spring operating gear; a spring about a rotation axis; a gear train; and a coupling arm connecting the rotation axis to the driving shaft by the gear train to transmit energy released by the spring from the rotation axis to the driving shaft, activating the driving shaft into rotation at a first speed. This spring motor allows storing energy in a spring; transmitting the stored energy to a driving shaft by linking an axis of the spring to the driving shaft by engaging the gear train; and reloading the spring; and reloading the spring by using a motor or transmitting energy from the driving shaft to the spring.

### CROSS REFERENCE TO RELATED APPLICATIONS

This application claims priority on U.S. provisional application Ser. No. 61/098,368, filed on Sep. 19, 2008. All documents above are incorporated herein in their entirety by reference.

### FIELD OF THE INVENTION

The present invention relates to motors. More specifically, the present invention is concerned with spring motors.

### SUMMARY OF THE INVENTION

More specifically, in accordance with the present invention, there is provided a spring motor for driving a driving shaft, comprising a spring operating gear; a spring about a rotation axis; a gear train; and a coupling arm connecting the rotation axis to the driving shaft by the gear train to transmit energy released by the spring from the rotation axis to the driving shaft, activating the driving shaft into rotation at a first speed.

There is further provided a powering method comprising storing energy in a spring; transmitting the stored energy to a driving shaft by the at least one gear train by linking an axis of the spring to the driving shaft by engaging at least one gear train; and reloading the spring by at least one of: i) using a motor and ii) transmitting energy from the driving shaft to the spring.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a general schematic view of a motor according to an embodiment of an aspect of the present invention;

FIG. 2 shows a spring and central axis in the motor of FIG. 1;

FIG. 3a schematically illustrates a motor with a mobile shaft, according to an embodiment of an aspect of the present invention, and FIG. 3b shows a detail of FIG. 3a;

FIG. 4 illustrates gear train configurations according to an embodiment of an aspect of the present invention;

FIG. 5 is a general schematic view of a motor according to a further embodiment of the present invention; and

FIG. 6 shows a spring and central axis in the motor of FIG. 5.

### DESCRIPTION OF EMBODIMENTS OF THE INVENTION

There is generally provided a spring motor for rotating a drive shaft, for powering a vehicle for example.

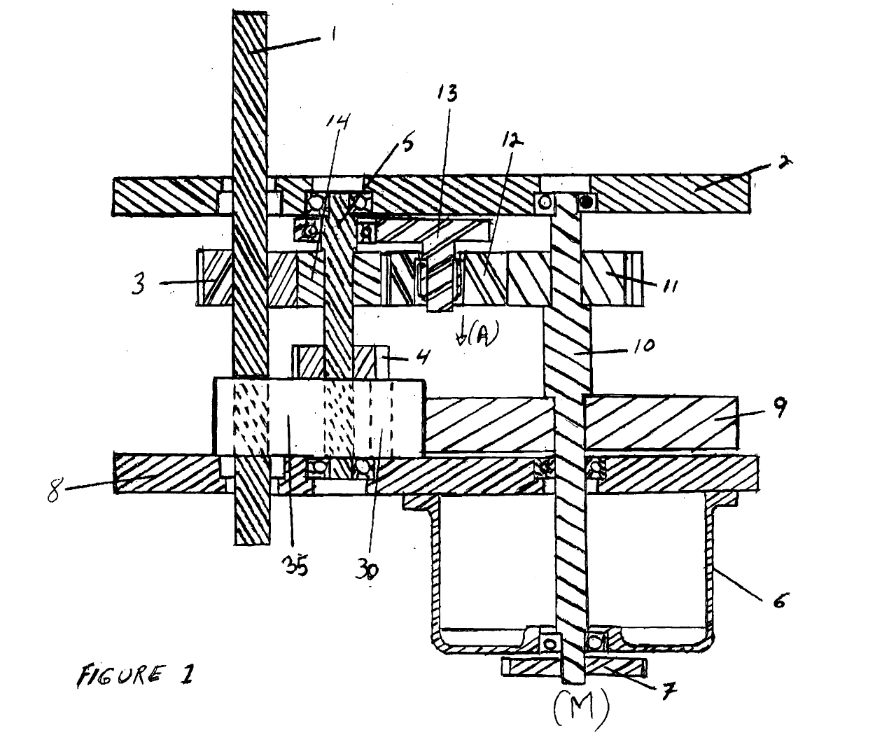

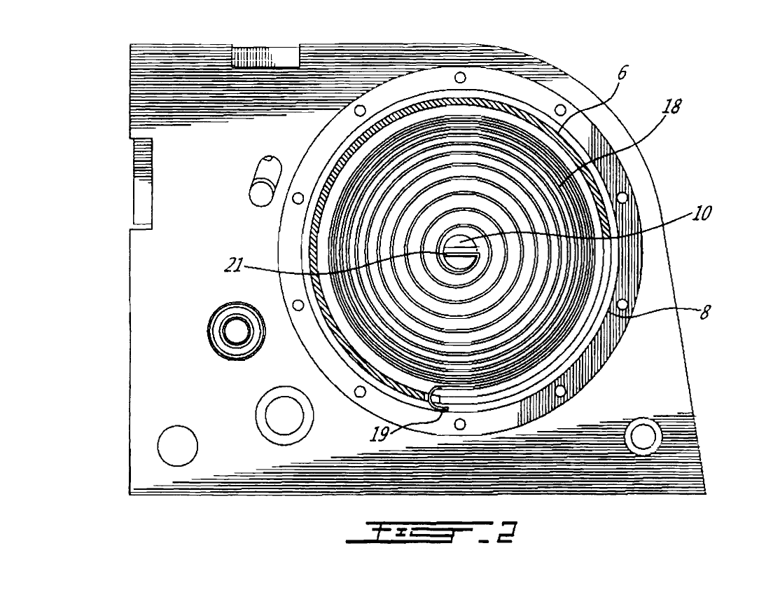

The assembly illustrated for exemplary purposes in FIG. 1 comprises a casing 6 housing a spring (not shown in FIG. 1).

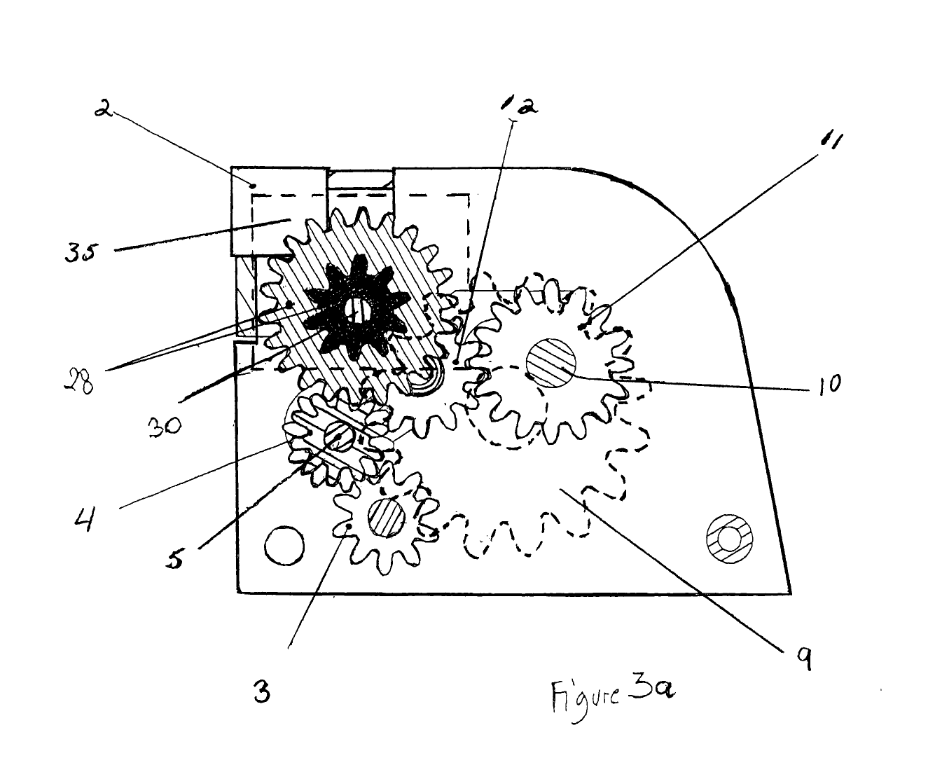

As best seen in FIG. 2, the spring 18 is wound around a central axis 10, with a first extremity 19 secured to the casing 6 and a second extremity 21 secured to the central axis 10.

In FIG. 2, the spring is illustrated as a spiral spring 18. A power spring or a constant force spring may be used. Other types of springs may be contemplated, such as torsion springs or even compression springs, providing additional guiding with a lever arm, for example, for compression of the spring. In the case of a torsion spring, a plate, perpendicular to the axis of the spring, may be used for driving the spring into rotation, for example. In the case of a compression spring, a plate with a guide within the plate may be used, for example.

As seen in FIG. 1, the axis 10 of the spring 18 extends out of the casing 6. At a first end of the central axis 10, the central axis 10 supports a gear 7, which is external to the casing 6. The second opposite end of the central axis 10 may be supported by a first support 2 or may be extended to support a second casing with a spring (not shown). The gear 7 is linked up to a small motor (M). This motor can be an electric motor, a hydraulic motor, a gasoline engine, a hybrid engine, or manual motor for example. The purpose of this motor (M) is to recharge the spring 18. When loading, the axis 10 rotates anti-clockwise. By turning the external gear 7 anti-clockwise, energy is stored in the spring 18 (shown in FIG. 2).

The casing 6 is fixed to a second support 8. The central axis 10 goes through the support 8 and mounts a gear 9 and a gear 11, and is supported by the first support 2 at the opposite end thereof.

The gear 11 is in mesh with a gear 12, which is coupled to a gear 14 by an arm 13, the gear 14 engaging a transmission shaft 5. The wheel shaft 1 secures the row formed of gears 11, 12 and 14 via a gear 3, and the support 8 together.

The transmission shaft 5 is supported by the walls 2 and 8 and holds two gears 4 and 14. The driving shaft 1 goes through the walls 2 and 8 and holds a gear 3. The gear 11 is in mesh with a gear 12, which is coupled to the gear 14 by the arm 13. When the arm 13 is pulled down (see arrow (A) in FIG. 1), the gears 11, 12 and 14 are connected together into a row and are able to transmit energy from the spring 18 (shown in FIG. 2) to the gear 3, which then drives the driving shaft 1 into rotation at a first speed. By pivoting the arm 13, the link between the gear 12 and the gear 14 may be disengaged, thereby disengaging the transmission shaft 5.

The gear 12 mainly acts during propulsion when energy is released by the spring 18 (shown in FIG. 2). However, the gear 12 may be used for recharging during backward movement of the vehicle, if needed: when the gears 12 and gear 14 are engaged, the arm 13 being in a low position, energy may be stored in the spring under action of the transmission shaft 5. This may be used to store energy as the vehicle is going backwards until a stop position for example.

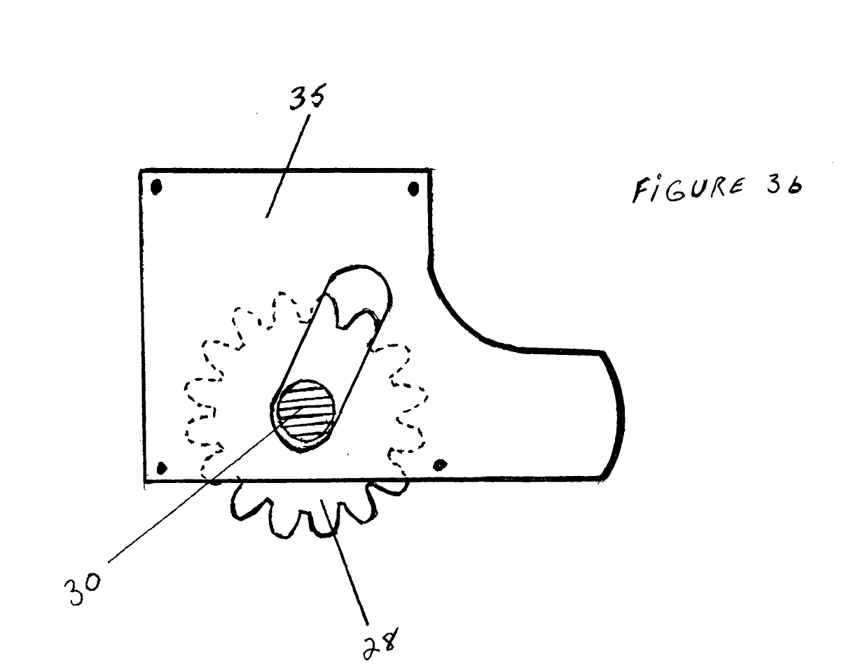

Alternatively, as illustrated in FIGS. 3 for example, a mobile shaft 30, with its gear 28, may further be provided to assist storing energy into the spring during backward motion. Use of the additional shaft 30 allows two different winding ratios for the spring.

In FIG. 1, a small casing 35 is shown (also shown in dotted lines in FIG. 3a), secured to the upper rear side of the wall 8. As best seen in FIG. 3b, this casing 35 holds the mobile shaft 30 (seen in dotted lines in FIG. 1) with its gear 28. The gear 28 is a two-size double gear, as can be seen in FIG. 3a.

As the vehicle goes forward and the shaft 30 is down, the smaller side of the gear 28 meshes with the gear 9, and the larger side of the gear 28 meshes with the gear 4 on the transmission shaft 5 to transmit the energy of the spring to the gear 3 on the driving shaft 1. The gear 28 thus meshing with gears 9 and 4 when the arm 13 is disengaged (lifted) allows driving the shaft 1 into rotation at a second speed.

As the vehicle goes forward, loading of the spring can be done with the shaft 30 up and gear 28 disengaged from gears 9 and 4, with the arm 13 up.

As the vehicle goes backward, the gear 28 may be engaged with gears 9 and 4 to assist storing energy into the spring.

Such an assembly may achieve an energy efficiency of up to 90%, since the energy waste is very limited. For example, friction may occur between the gears, or between spirals of the spring bar or wire of the spiral spring.

The present gear set allows exchanging energy with the spring in the casing 6 by transmitting a rotation movement between the central axis 10 and the transmission shaft 5.

The energy output occurs parallel to the central axis 10.

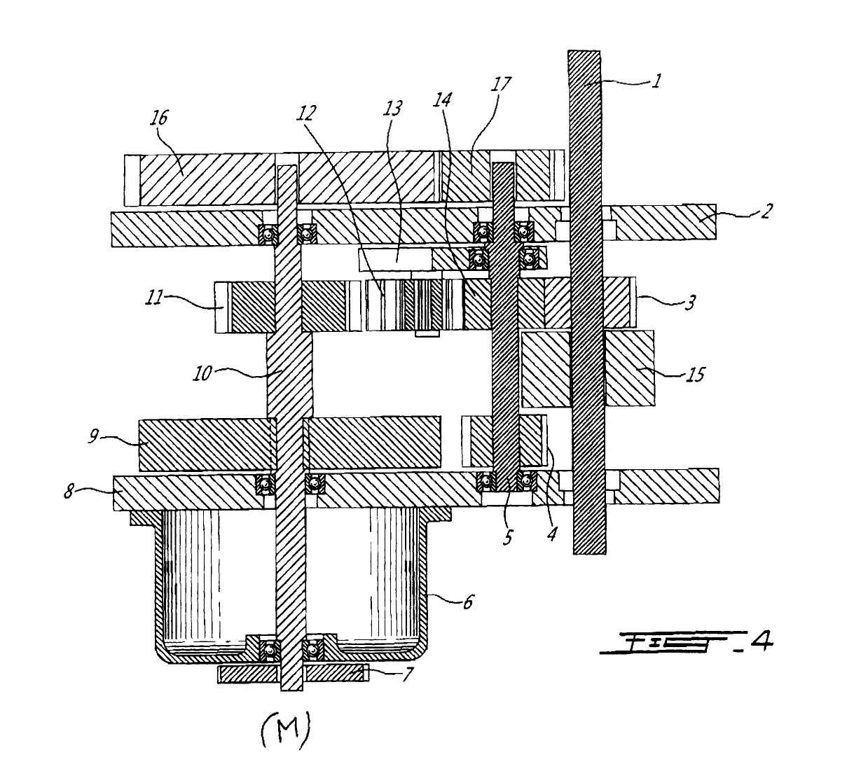

Alternatively, as illustrated in FIG. 4, an uneven gear train may be used to yield a forward propulsion of the vehicle when the arm 13 is lowered and the gear 12 connects gears 11 and 14. Then the spring may be recharged when the vehicle moves forward, provided gears 16 or 17 are disengaged from their respective shaft 10 and 5 respectively.

A pair gear train configuration allows backward movement of the vehicle when the arm 13 is lifted up and gears 16 and 17 are engaged to their respective shaft 10 and 5 respectively. Such a configuration also allows reloading the spring upon forward movement of the vehicle. The gears 16 and 17 may be engaged by an electronic mechanism in order to allow recovering energy upon braking or upon a downhill movement of the vehicle.

Also shown in FIG. 4, an inertia mass 15 (or several) may be provided around the wheel shaft 1 to more efficiently control the release of energy, so as to prevent, for example, an abrupt propulsion when the spring is released. Part of the kinetic energy may also be stored during downhill movement, or the inertia accumulated during disengagement of the gear 12 following the release of energy stored in the spring.

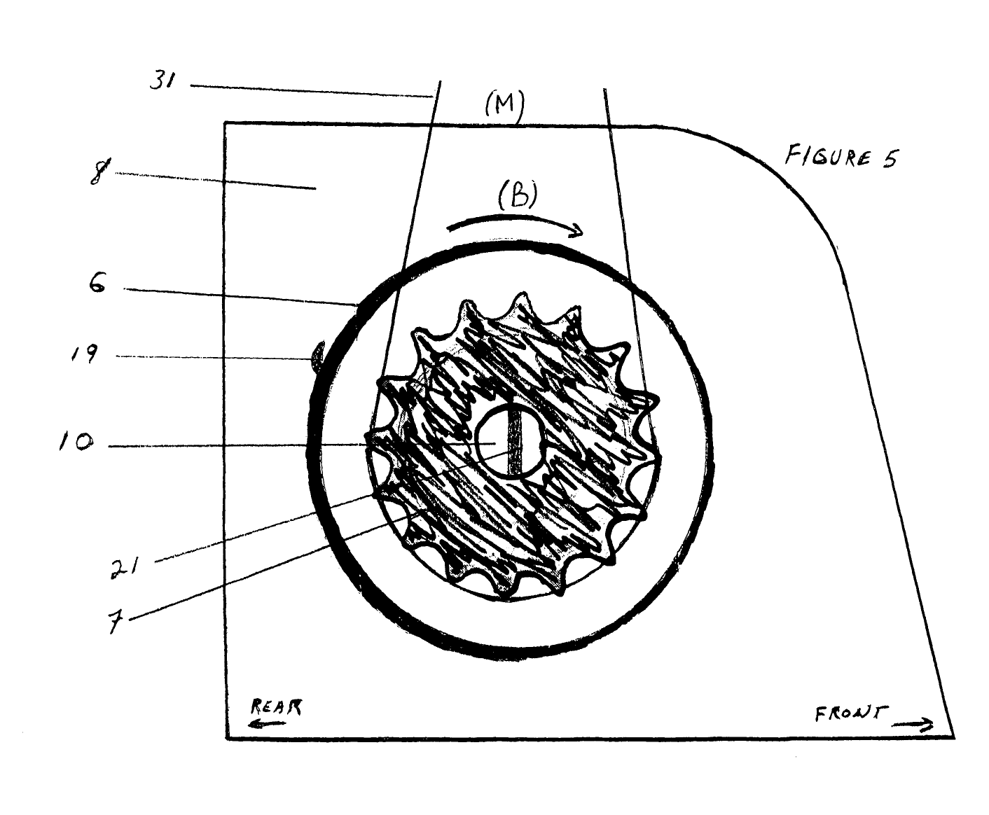

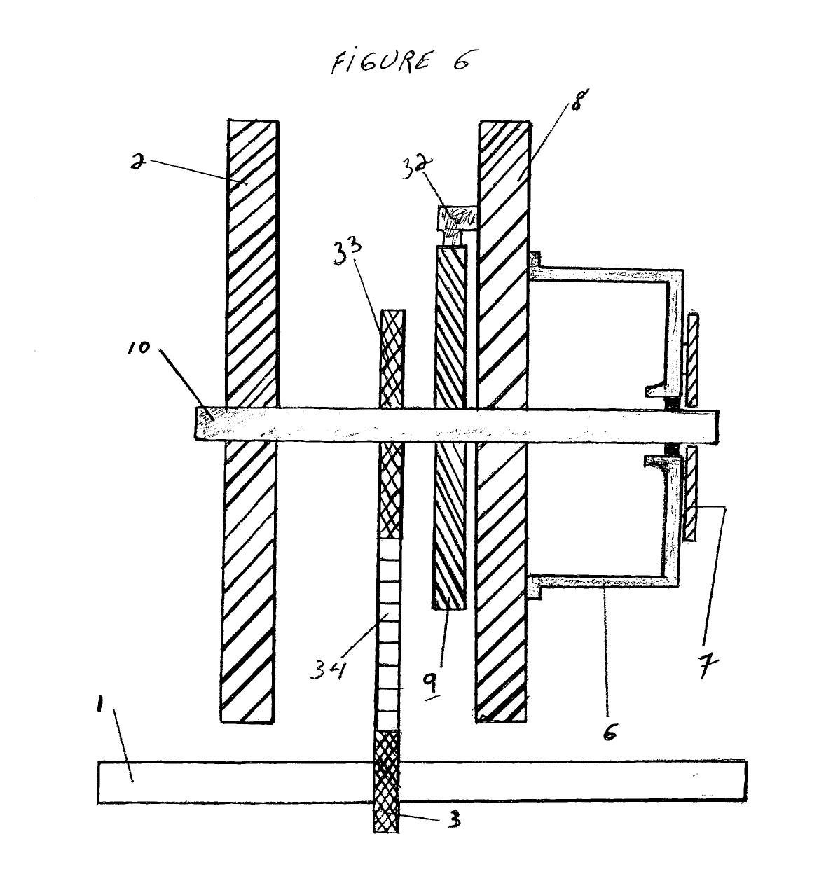

A further embodiment is illustrated in FIGS. 5 and 6. As best seen in FIG. 5, the spring 18 is wound around a central axis 10, with a first extremity 19 thereof secured to the casing 6 and a second extremity 21 thereof secured to the central axis 10.

The gear 7 is fixed to the casing 6. The gear 7 is linked up by a chain, a strap or else 31 to a motor (M). This motor can be an electric motor, a hydraulic motor, a gasoline engine, a hybrid engine, or manual motor for example. The purpose of this motor is to recharge the spring.

As seen in FIG. 5, the entire casing 6 turns clockwise (see arrow (B)) about the central axis 10, which is held still.

As best seen in FIG. 6, the central axis 10 extends out of the casing 6. At a first end thereof, the central axis 10 supports the external gear 7, which is fixed to the casing 6. The second opposite end of the central axis 10 is supported by the wall 2, as shown, or could be extended to support a second casing with a spring. On the side of this second end of the central axis 10, the central axis 10 goes through a wall 8 and mounts a gear 9 and a gear 33.

A gear 33 is aligned with a gear 3 about the driving shaft 1. The gear 33 is linked up to gear 3 by a chain, a strap or else 34. An arm 32 may be pulled down to hold a gear 9 that maintains the spring central axis 10 still upon loading. The power of the spring is released by pulling the arm 32 up, thus releasing the spring central axis 10, which then rotates clockwise to bring the vehicle forward. The reloading of the spring may take place as the vehicle is moving.

As people in the art will now be in a position to appreciate, the present invention allows reloading a motor without reverting to the wheels of the vehicle, using an external gear 7 to reload a spring 18.

Motors with different gear ratios may be paired according to different needs. Alternatively, a first motor with constant force springs used to obtain a relatively low surge and characterized by a long lifetime, may be paired with a second motor comprising a pair gear train so as to allow recharging during forward movement while allowing backward movement. Pairing motors in series allows yielding a continuous surge and allows recharging a first one of the motors while a second one of the motors of the series provides the surge. Motors may also be used in parallel to increase the generated power, which may be needed for example upon starting the vehicle, or when going uphill or for an acceleration.

When using a single spring motor as described hereinabove to power a vehicle, reloading of the spring may take place as the vehicle is on its way, i.e. by using its residual movement. Alternatively, it may be contemplated using several spring motors as described hereinabove, in such a way that at least one operates while at least a second one reloads as described hereinabove.

A motor may comprise more than one spring, to increase generation of power. In this case, while all springs are mounted about a same shaft, they may be located in different casings on each side of the motor for example.

Although the present invention has been described hereinabove by way of embodiments thereof, it may be modified, without departing from the nature and teachings of the subject invention as described herein.

What is claimed is:

1. A spring motor for driving a driving shaft, comprising:
a spring operating gear;
at least one spring about a rotation axis;
at least one gear train; and
a coupling arm;
wherein said coupling arm connects said rotation axis to the driving shaft by said at least one gear train to transmit energy released by said spring from said rotation axis to said driving shaft, activating said driving shaft into rotation at a first speed.

2. The spring motor of claim 1, wherein said spring operating gear is used to store energy in said spring.

3. The spring motor of claim 1, wherein said at least one gear train is used to store energy in said spring from said driving shaft.

4. The spring motor of claim 1, further comprising a mobile shaft with an associated double gear, said double gear being able to mesh with a gear of said central axis and with a gear of a transmission shaft connecting said driving shaft and said at least one gear train.

5. The spring motor of claim 4, said double gear transmitting energy of the spring to a gear on the driving shaft and activating said driving shaft into rotation at a second speed upon a forward movement as said double gear meshes with the gear of said central axis and with the gear of the transmission shaft, said coupling arm being disengaged.

6. The spring motor of claim 4, said double gear meshes with the gear of said central axis and with the gear of the transmission shaft, and assists storing energy into said spring upon a backward movement.

7. The spring motor of claim 4, wherein said double gear is unmeshed from the gear of said central axis and from the gear the transmission shaft, and, said coupling arm being disengaged, said spring is loaded upon a forward movement.

8. The spring motor of claim 1, further comprising an inertia mass about said driving shaft, said inertia mass controlling the release of energy from the spring to said driving shaft.

9. The spring motor of claim 1, wherein said spring operating gear is connected to a motor.

10. The spring motor of claim 1, wherein said spring is one of: a spiral spring; a torsion spring, and a compression spring.

11. The spring motor of claim 1, wherein said spring is one of: a power spring and a constant force spring.

12. A vehicle powered by the spring motor of claim 1.

13. A powering method, comprising:
storing energy in a spring;
transmitting the stored energy to a driving shaft by at least one gear train; and
reloading the spring;
wherein said transmitting the stored energy comprises linking an axis of the spring to the driving shaft by engaging said at least one gear train; and said reloading comprises at least one of: i) using a motor and ii) transmitting energy from the driving shaft to the spring.
